(19) United States
(12) Patent Application Publication
(10) Pub. No.: US 2024/0394505 A1
(43) Pub. Date: Nov. 28, 2024

(54) METHOD FOR DETERMINING AN ARCHITECTURE OF A MULTITASKING MODEL

(71) Applicant: Robert Bosch GmbH, Stuttgart (DE)

(72) Inventors: Claudia Blaiotta, Stuttgart (DE); Lukas Schott, Stuttgart (DE)

(21) Appl. No.: 18/663,720

(22) Filed: May 14, 2024

(30) Foreign Application Priority Data
May 22, 2023 (DE) 10 2023 204 753.5

(51) Int. Cl. G06N 3/04; G06N 3/08

(52) U.S. Cl. CPC G06N 3/04; G06N 3/08

(57) ABSTRACT

A method for determining an architecture of a multitasking model with a number of L layers Lᵢ with i=1 to L for achieving a set of at least two, in particular a plurality of, mutually different tasks Tᵢ with i= [symbol] >2. The method includes: for the set of tasks to be achieved, estimating pairwise affinities between the tasks to be achieved of the set; assigning the tasks to be achieved to a number of N groups gᵢ with i=1 to N on the basis of the pairwise affinities; and determining a branching depth of the multitasking model with layer, wherein the branching depth specifies at what depth of the layers of the multitasking model a base network of the multitasking model that is shared by the tasks to be achieved branches into a number of N branch networks Zᵢ with i=1 to N.

### CROSS REFERENCE

The present application claims the benefit under 35 U.S.C. § 119 of German Patent Application No. DE 10 2023 204 753.5 filed on May 22, 2023, which is expressly incorporated herein by reference in its entirety.

### FIELD

The present invention relates to a method for determining a method for determining an architecture of a multitasking model, to a multitasking model for achieving at least two, in particular a plurality of, mutually different tasks, with an architecture determined according to such a method, and to a computer program product.

### BACKGROUND INFORMATION

Multitask learning or also multitasking is a subarea of machine learning that deals with models that can achieve a plurality of tasks in parallel. A common paradigm in multitasking is to train a single neural network to achieve various tasks simultaneously. The typical architecture of a multitasking network consists of a common base network, also referred to as a backbone, which functions as a type of feature extractor and whose weights are shared by all tasks, and dedicated branch networks, also referred to as heads or headers, whose weights are not shared by all tasks. In such an environment, the tasks to be achieved can affect one another either constructively or destructively within the common base network during the training of the neural network.

The present invention provides a method by means of which an architecture of a multitasking model can be determined in such a way that destructive interaction between the tasks is minimized.

### SUMMARY

One example embodiment of the present invention relates to a method for determining an architecture of a multitasking model with a number of L layers Lᵢ with i=1 to L for achieving a set of at least two, in particular a plurality of, mutually different tasks Tᵢ with i= [symbol] ≥2, the method comprising the following steps:
for the set of tasks Tᵢ to be achieved, estimating pairwise affinities between the tasks Tᵢ to be achieved of the set;
assigning the tasks Tᵢ to be achieved to a number of N groups gᵢ with i=1 to N on the basis of the pairwise affinities; and
determining a branching depth d of the multitasking model with layers Lᵢ, wherein the branching depth d specifies at what depth of the layers Lᵢ of the multitasking model a base network B of the multitasking model that is shared by the tasks Tᵢ to be achieved branches into a number of N branch networks Zᵢ with i=1 to N.

The method provides that the estimated pairwise affinity of the tasks is used to design a single multitasking network in which negative interactions between the tasks are mitigated. Separate base networks, also backbones, are thus not used, and the tasks to be achieved are also not assigned to separate networks. According to the present invention, the architecture of a single network with a tree topology in which a plurality of branch networks, also headers, is connected to a common base network, backbone, is determined. In other words: The method allows a finer division in which a portion of the neural network can continue to be shared by various tasks, e.g., in low layers of a single neural network.

The common base network functions as a feature extractor, and the weights of the common base network are shared by the tasks to be achieved. The branch networks are subnetworks dedicated according to tasks, and their weights are not used by all but in each case only by dedicated tasks.

The tasks are assigned to the branch networks on the basis of the assignments of the tasks to the N groups gᵢ. For the method, this means that these assignments are available as a result of the preceding step.

The purpose of the step for determining the branching depth d is to determine the optimal depth of the layers Lᵢ of the multitasking model at which the shared base network, backbone, is located or branches. For example, a branching depth d=2 means that the base network comprises layers 1 and 2 of the multitasking model and that branching into branch networks is provided after layer 2.

Thus, not only are the affinities between the tasks calculated, but an optimal depth of the common backbone is also determined in order to define where conflicts between tasks could occur. The method thus determines whether it is still possible to share latent representations, before the network is divided. In this way, computational costs can be drastically reduced, which is particularly helpful in image processing and other high-dimensional areas where the calculations in the early layers are often quite task-independent and computationally intensive.

According to one example embodiment of the present invention, it is provided that a pairwise affinity specifies a value of how well a respective pair of tasks can be trained in a shared layer network. A high affinity value means a positive interference between the pair of tasks, while a low affinity value means a negative interference between the pair of tasks. For example, the pairwise affinity can be determined by jointly training a pair of tasks in a single multitask network and quantifying the effect a gradient update of a task has on another task. More than one pair of tasks can also be jointly trained in the single multitask network.

According to one example embodiment of the present invention, it is provided that a pairwise affinity comprises one affinity value for the first task of the pair and one affinity value for the second task of the pair. For example, for a pair of tasks comprising a task Tₐ and a task T_{b}, the affinity value for task Tₐ is Z_{a→b} and the affinity value for task T_{b} is Z_{a→b}. The affinity values are not necessarily symmetrical, i.e., Z_{b→b} can be unequal to Z_{a→b}.

For a set of tasks comprising three or more tasks, the affinity of a particular task can be determined by determining the average of the pairwise affinities for that particular task. For example, for a set comprising the tasks Tₐ, T_{b}, T_{c}, the affinity value for task Tₐ can be calculated by averaging the pairwise affinities of tasks T_{b} and T_{c} for Tₐ: (Z_{b→a}+Z_{c→a})/2.

The determination of affinities is described, for example, in Fifty, Chris, et al. “Efficiently identifying task groupings for multi-task learning” Advances in Neural Information Processing Systems 34 (2021): 27503-27516 and in Standley, Trevor, et al. “Which tasks should be learned together in multi-task learning?” International Conference on Machine Learning. PMLR, 2020.

According to one example embodiment of the present invention, it is provided that the tasks to be achieved are assigned to groups gᵢ in such a way that an average pairwise affinity value of a respective group gᵢ is maximized. The tasks to be achieved may be assigned disjointly to groups gᵢ. Alternatively, the assignment does not necessarily have to be disjoint. Furthermore, since the affinity values are not necessarily symmetrical, it may be advantageous if assigning takes place in an overcomplete manner. This means that a task can be assigned to two or more groups. For example, for a pair of tasks comprising a task Tₐ and a task T_{b} and the affinity values Z_{b→a}, Z_{a→b}, it is true that Z_{a→b}>Z_{b→a}, wherein the value Z_{a→b} comprises a correspondingly high value and there is thus positive interference with respect to task T_{b} when the task Tₐ is trained with the task T_{b}. For example, the value Z_{b→a} comprises a correspondingly low value so that there is negative interference with respect to task Tₐ when the task T_{b} is trained with the task Tₐ. In other words, task Tₐ would thus increase the performance of task T_{b}, but not vice versa. In this case, it is advantageous if the tasks Tₐ and T_{b} are assigned to the same group, but the task Tₐ is additionally assigned to a further group to which the task T_{b} is not assigned.

According to an example embodiment of the present invention, it may be advantageous if a maximum number N of the groups is specified. For example, the maximum number can thus be adjusted to the available computing resources.

The problem of assigning the tasks to be achieved to groups can be efficiently solved with branch-and-bound or binary integer programming (BIP) solvers.

According to one example embodiment of the present invention, it is provided that determining the branching depth d comprises: training a plurality of networks with mutually different branching depths, and selecting a branching depth on the basis of a predictive accuracy of the networks. The predictive accuracy can, for example, be determined with appropriate validation data.

Approaches from the related art use neural architecture search (NAS) methods to estimate an optimal branching configuration by training a much larger neural network that contains all possible branchings as subnetworks. Through the training of a plurality of individual networks, the present method makes it possible to find the optimal branching depth with a computationally simple program that requires significantly less GPU memory for each individual run since an entire supergraph is not determined all at once.

In principle, after determining the branching depth d, the above-described method can be repeated iteratively. This is described below on the basis of subgroups and subbranch networks.

According to one example embodiment of the present invention, it is provided that, for a respective group gᵢ comprising two or more tasks, it is checked whether assigning the tasks to be achieved of the respective group gᵢ to a number of M subgroups (ugᵢ) with i=1 to M increases an average pairwise affinity value of a respective group gᵢ.

According to one example embodiment of the present invention, it is provided that the following steps are performed if the check indicates that the pairwise affinity value of a respective group gᵢ is increased:
assigning the tasks Tᵢ to be achieved of a respective group gᵢ to a number of M subgroups ugᵢ with i=1 to M on the basis of the pairwise affinities, and determining a subbranching depth ud in a respective branch network Zᵢ, wherein the subbranching depth ud specifies at what depth of the layers Lᵢ of the branch Zᵢ the branch Zᵢ branches into a number of M subbranch networks UZᵢ with i=1 to M.

The goal of further branching into subbranch networks is to further split an i-th branch network into M subbranch networks. The optimal subbranching depth ud is in the set {d+1, d+2, . . . , L−1}, i.e., at a depth greater than the branching depth d.

According to one example embodiment of the present invention, it is provided that the steps for checking and assigning, which are described above for a respective group gᵢ, are performed iteratively for a respective subgroup ugᵢ. In this way, the architecture of the multitasking model can be even further improved.

Further embodiments of the present invention relate to a multitasking model with a number of L layers for achieving at least two, in particular a plurality of, mutually different tasks, with an architecture determined according to a method according to the described embodiments of the present invention.

Further embodiments of the present invention relate to a computer program product that, when executed on a computer, causes the computer to perform a method according to the above-described embodiments of the present invention.

Further embodiments of the present invention relate to a use of the method according to the above-described embodiments of the present invention to determine an architecture of a multitasking model with a number of L layers for achieving at least two, in particular a plurality of, mutually different tasks and/or to determine the multitasking model with a number of L layers for achieving at least two, in particular a plurality of, mutually different tasks.

According to one embodiment of the present invention, it is provided that the multitasking model is designed or trained to achieve tasks in the area of object recognition and/or for controlling a technical system, in particular also to achieve tasks in both areas. The areas of object recognition and of controlling the technical system are used, for example, in the area of autonomous or semi-autonomous driving and in robotics.

For example, a multitude of digital images, in particular digital video images, digital radar images, digital lidar images, digital ultrasonic images, or digital motion sensor images are provided for object recognition. The multitasking model is trained for object recognition. The trained multitasking model is designed to ascertain a result of a classification of at least one object in a digital image. In order to control a movement of a technical system, the method comprises capturing the digital image with a sensor, controlling the movement of the technical system, in particular of a machine, a robot, a vehicle, an aircraft, depending on the result of the classification of the at least one object in the digital image.

A multitasking model with an architecture determined according to the above-described method of the present invention can advantageously be used to achieve a plurality of tasks simultaneously in an environment with limited computing budget. For example, in autonomous driving, the autonomous agent must achieve a plurality of tasks in real-time, such as locating and classifying other road users, e.g., motor vehicles, pedestrians, cyclists, etc., identifying drivable surfaces, recognizing traffic signs, etc., wherein the available computing power is limited by the hardware present in the vehicle.

Further advantages arise from the description and the accompanying drawings. Exemplary embodiments of the present invention are shown in the figures and are explained in more detail in the following description. In this respect, the same reference signs in different figures respectively refer to the same elements or to elements that are at least comparable in terms of their function. In the description of individual figures, reference is, where appropriate, also made to elements from other figures.

### BRIEF DESCRIPTION OF THE DRAWINGS

FIG. 1 shows a representation of models from the related art.

FIG. 2 shows a multitasking model with an architecture according to a first example embodiment of the present invention.

FIG. 3 shows a multitasking model with an architecture according to a second example embodiment of the present invention.

FIG. 4 shows steps of a method for determining an architecture of a multitasking model NN.

### DETAILED DESCRIPTION OF EXAMPLE EMBODIMENTS

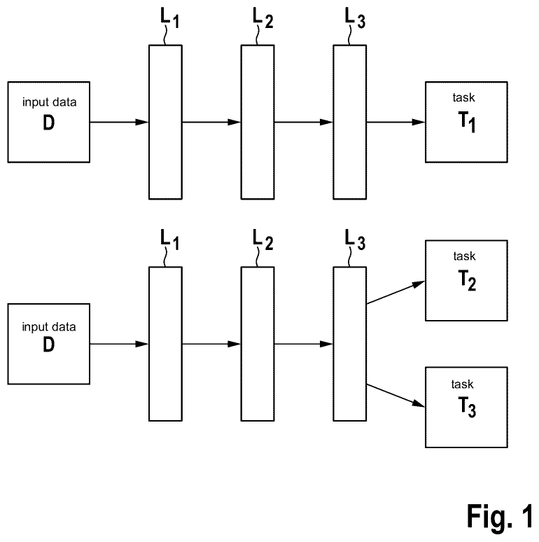

From the related art, cf. FIG. 1, different tasks are assigned to different models. According to the disclosures Fifty, Chris, et al. “Efficiently identifying task groupings for multi-task learning” Advances in Neural Information Processing Systems 34 (2021): 27503-27516 and Standley, Trevor, et al. “Which tasks should be learned together in multi-task learning?” International Conference on Machine Learning. PMLR, 2020, affinities between tasks are used to assign task groups to individual networks.

The present invention relates to a method that uses the pairwise affinity of tasks to design a single multitasking network in which negative interactions between the tasks are mitigated. According to the method of the present invention, separate base networks, also backbones, are thus not used, and the tasks to be achieved are also not assigned to separate networks. According to the present invention, the architecture of a single network with a tree topology in which a plurality of branch networks, also headers, is connected to a common base network, backbone, is determined. By sharing computing resources, multitasking architectures are generally more favorable in terms of the compromise between efficiency and accuracy than a collection of independent singletasking networks.

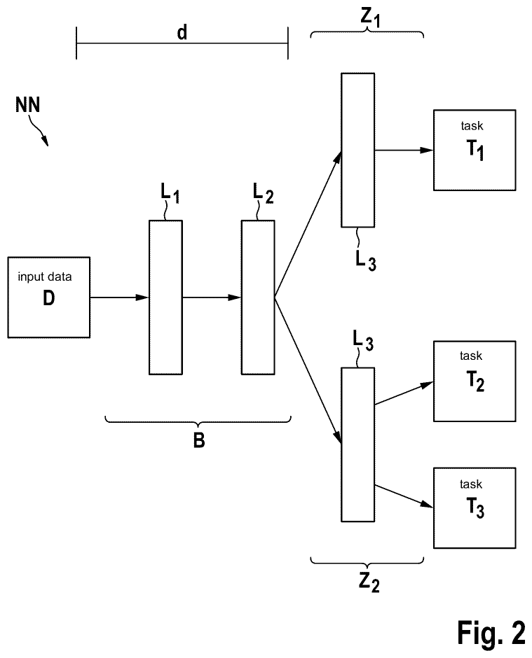

With reference to FIGS. 2 to 4, a method 100 for determining an architecture of a multitasking model NN, for example a neural network, is explained below.

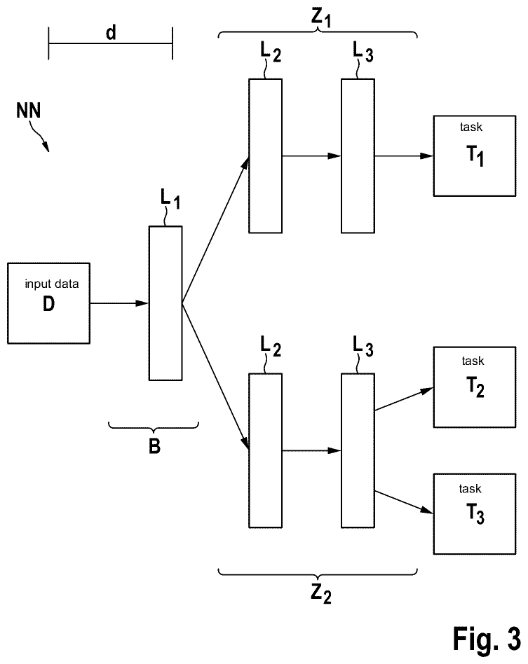

For example, FIGS. 2 and 3 show a multitasking model with an architecture according to a first embodiment and a multitasking model with an architecture according to a second embodiment.

A multitasking model NN comprises a number of L layers Lᵢ with i=1 to L for achieving a set of at least two, in particular a plurality of, mutually different tasks Tᵢ with i= [symbol] ≥2.

In the example, the multitasking model NN comprises a number of L=3 layers L₁, L₂, and L₃ for achieving a set of, by way of example, three mutually different tasks T₁, T₂, T₃.

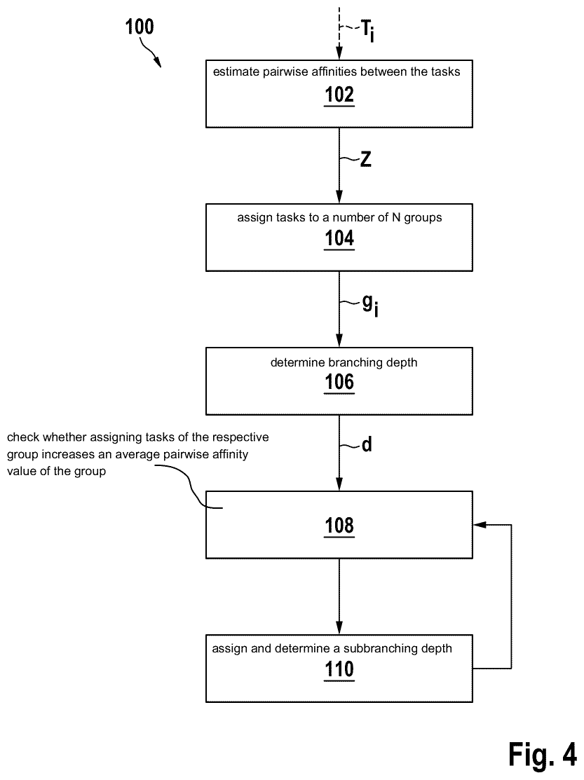

The method 100 provides the following steps, cf. also FIG. 4:

In a step 102, for the set of tasks Tᵢ to be achieved, pairwise affinities between the tasks Tᵢ to be achieved of the set are estimated.

The pairwise affinity specifies a value of how well a respective pair of tasks Tₐ, T_{b} can be trained in a network with shared layers Lᵢ. A high affinity value means a positive interference between the pair of tasks, while a low affinity value means a negative interference between the pair of tasks. For example, the pairwise affinity can be determined by jointly training a pair of tasks in a single multitask network and quantifying the effect a gradient update of a task has on another task. More than one pair of tasks can also be jointly trained in the single multitask network.

According to one embodiment, it is provided that a pairwise affinity comprises one affinity value for the first task of the pair and one affinity value for the second task of the pair. For example, for a pair of tasks comprising a task Tₐ and a task T_{b}, the affinity value for task Tₐ is Z_{b→a} and the affinity value for task T_{b} is Z_{a→b}. The affinity values are not necessarily symmetrical, i.e., Z_{b→a} can be unequal to Z_{a→b}.

For a set of tasks comprising three or more tasks, the affinity of a particular task can be determined by determining the average of the pairwise affinities for that particular task. For example, for a set comprising the tasks Tₐ, T_{b}, T_{c}, the affinity value for task Tₐ can be calculated by averaging the pairwise affinities of tasks T_{b} and T_{c} for Tₐ: (Z_{b→a}+Z_{c→a})/2

In a step 104, the tasks Tᵢ to be achieved are assigned to a number of N groups gᵢ with i=1 to N on the basis of the pairwise affinities.

For example, the tasks Tᵢ to be achieved are assigned to groups gᵢ in such a way that an average pairwise affinity value of a respective group gᵢ is maximized. The tasks Tᵢ to be achieved may be assigned disjointly to groups gᵢ. Alternatively, the assignment does not necessarily have to be disjoint. Furthermore, since the affinity values are not necessarily symmetrical, it may be advantageous if assigning takes place in an overcomplete manner. This means that a task Tᵢ can be assigned to two or more groups. For example, for a pair of tasks comprising a task Tₐ and a task T_{b} and the affinity values Z_{b→a}, Z_{a→b}, it is true that Z_{a→b}>Z_{b→a}, wherein the value Z_{a→b} comprises a correspondingly high value and there is thus positive interference with respect to task T_{b} when the task Tₐ is trained with the task T_{b}. For example, the value Z_{b→a} comprises a correspondingly low value so that there is negative interference with respect to task Tₐ when the task T_{b} is trained with the task Tₐ. In other words, task Tₐ would thus increase the performance of task T_{b}, but not vice versa. In this case, it is advantageous if the tasks Tₐ a and T_{b} are assigned to the same group gᵢ, but the task Tₐ is additionally assigned to a further group gᵢ to which the task is not assigned.

A maximum number N of the groups gᵢ may be specified.

The problem of assigning the tasks Tᵢ to be achieved to groups gᵢ can be efficiently solved with branch-and-bound or binary integer programming (BIP) solvers.

In a step 106, a branching depth d of the multitasking model NN with layers Lᵢ is determined, wherein the branching depth d specifies at what depth of the layers Lᵢ of the multitasking model a base network B of the multitasking model that is shared by the tasks Tᵢ to be achieved branches into a number of N branch networks Zᵢ with i=1 to N.

The common base network B functions as a feature extractor, and the weights of the common base network B are shared by the tasks to be achieved. The branch networks Zᵢ are subnetworks dedicated according to tasks, and their weights are not used by all but in each case only by dedicated tasks.

The tasks Tᵢ are assigned to the branch networks Zᵢ on the basis of the assignments of the tasks Tᵢ to the N groups gᵢ. For the method, this means that these assignments are available as a result of the preceding step 104.

The purpose of the step 106 for determining the branching depth d is to determine the optimal depth of the layers Lᵢ of the multitasking model NN at which the shared base network B, backbone, is located or branches. For example, a branching depth d=2 means that the base network comprises layers 1 and 2 of the multitasking model and that branching into branch networks Z₁, Z₂ is provided after layer 2, cf. FIG. 2. For example, a branching depth d=1 means that the base network comprises layer 1 of the multitasking model and that branching into branch networks Z₁, Z₂ is provided after layer 1, cf. FIG. 3.

According to one embodiment, it is provided that determining the branching depth d comprises: training a plurality of networks with mutually different branching depths, and selecting an optimal branching depth on the basis of a predictive accuracy of the networks. The predictive accuracy can, for example, be determined with appropriate validation data. For example, a network according to FIG. 2 and a network according to FIG. 3 can be trained, and the optimal branching depth can be determined on the basis of the predictive accuracy of the networks. Preferably, the optimal branching depth is additionally selected depending on a required computer resource consumption of the architecture of the neural network.

In principle, after determining the branching depth d, step 106, the already described method can be repeated iteratively. This is described below on the basis of subgroups and subbranch networks.

According to one embodiment, it is provided that, for a respective group gᵢ comprising two or more tasks, it is checked whether assigning the tasks to be achieved of the respective group gᵢ to a number of M subgroups ugᵢ with i=1 to M increases an average pairwise affinity value of a respective group gᵢ, step 108.

According to one embodiment, it is provided that the following steps (combined into step 110) are performed if the check indicates that the pairwise affinity value of a respective group gᵢ is increased:
assigning the tasks Tᵢ to be achieved of a respective group gᵢ to a number of M subgroups ugᵢ with i=1 to M on the basis of the pairwise affinities, and determining a subbranching depth ud in a respective branch network Zᵢ, wherein the subbranching depth ud specifies at what depth of the layers Lᵢ of the branch Zᵢ the branch Zᵢ branches into a number of M subbranch networks UZᵢ with i=1 to M.

The goal of further branching into subbranch networks is to further split an i-th branch network into M subbranch networks.

The optimal subbranching depth ud is in the set {d+1, d+2, . . . , L−1}, i.e., at a depth greater than the branching depth d.

According to one embodiment, it is provided that the steps for checking and assigning, which are described above for a respective group gᵢ, are performed iteratively for a respective subgroup ugᵢ. In this way, the architecture of the multitasking model can be even further improved.

Further embodiments relate to a use of the method 100 according to the described embodiments to determine an architecture of a multitasking model NN with a number of L layers for achieving at least two, in particular a plurality of, mutually different tasks Tᵢ and/or to determine the multitasking model NN with a number of L layers for achieving at least two, in particular a plurality of, mutually different tasks Tᵢ.

According to one embodiment, it is provided that the multitasking model is designed or trained to achieve tasks in the area of object recognition and/or for controlling a technical system, in particular also to achieve tasks in both areas. The areas of object recognition and of controlling the technical system are used, for example, in the area of autonomous or semi-autonomous driving and in robotics.

For example, a multitude of digital images, cf. input data D in FIGS. 3 and 4, in particular digital video images, digital radar images, digital lidar images, digital ultrasonic images, or digital motion sensor images are provided for object recognition. The multitasking model is trained for object recognition. The trained multitasking model is designed to ascertain a result of a classification of at least one object in a digital image. In order to control a movement of a technical system, the method comprises capturing the digital image with a sensor, controlling the movement of the technical system, in particular of a machine, a robot, a vehicle, an aircraft, depending on the result of the classification of the at least one object in the digital image.

What is claimed is:

1. A method for determining an architecture of a multitasking model with a number of L layers Lᵢ with i=1 to L for achieving a set of a plurality of mutually different tasks Tᵢ with i= [symbol] ≥2, the method comprising the following steps:
for the set of tasks to be achieved, estimating pairwise affinities between the tasks to be achieved of the set;
assigning the tasks to be achieved to a number of N groups gᵢ with i=1 to N based on the pairwise affinities; and
determining a branching depth of the multitasking model with layers, wherein the branching depth specifies at what depth of the layers of the multitasking model a base network of the multitasking model that is shared by the tasks to be achieved branches into a number of N branch networks Zᵢ with i=1 to N.

2. The method according to claim 1, wherein each pairwise affinity specifies a value of how well a respective pair of the tasks can be trained in a shared layer network.

3. The method according to claim 1, wherein the tasks to be achieved are assigned to the groups in such a way that an average pairwise affinity value of a respective group is maximized.

4. The method according to claim 1, wherein determining the branching depth includes: training a plurality of networks with mutually different branching depths, and selecting an optimal branching depth based on a predictive accuracy of the networks.

5. The method according to claim 1, wherein, for a respective group including two or more of the tasks, it is checked whether assigning the tasks to be achieved of the respective group to a number of M subgroups ugᵢ with i=1 to M increases an average pairwise affinity value of the respective group.

6. The method according to claim 5, wherein the following steps are performed when the check indicates that the pairwise affinity value of the respective group is increased:
assigning the tasks to be achieved of the respective group to a number of M subgroups ugᵢ with i=1 to M based on the pairwise affinities, and determining a subbranching depth in a respective branch network, wherein the subbranching depth specifies at what depth of the layers of a branch branches into a number of M subbranch networks UZᵢ with i=1 to M.

7. The method according to claim 6, wherein the steps of checking, assigning to subgroups, and determining the subbranching are performed iteratively for each respective subgroup ugᵢ.

8. A multitasking model with a number of L layers for achieving a plurality of mutually different tasks, the multitasking model having an architecture determined for achieving a set of a plurality of mutually different tasks Tᵢ with i= [symbol] ≥2, the architecture being determined by:
for the set of tasks to be achieved, estimating pairwise affinities between the tasks to be achieved of the set;
assigning the tasks to be achieved to a number of N groups gᵢ with i=1 to N based on the pairwise affinities; and
determining a branching depth of the multitasking model with layers, wherein the branching depth specifies at what depth of the layers of the multitasking model a base network of the multitasking model that is shared by the tasks to be achieved branches into a number of N branch networks Zᵢ with i=1 to N.

9. A non-transitory computer-readable medium on which is stored a computer program for determining an architecture of a multitasking model with a number of L layers Lᵢ with i=1 to L for achieving a set of a plurality of mutually different tasks Tᵢ with i= [symbol] ≥2, the computer program, when executed by a computer, causing the computer to perform the following steps:
for the set of tasks to be achieved, estimating pairwise affinities between the tasks to be achieved of the set;
assigning the tasks to be achieved to a number of N groups gᵢ with i=1 to N based on the pairwise affinities; and
determining a branching depth of the multitasking model with layers, wherein the branching depth specifies at what depth of the layers of the multitasking model a base network of the multitasking model that is shared by the tasks to be achieved branches into a number of N branch networks Zᵢ with i=1 to N.
